(19) United States
(12) Patent Application Publication
(10) Pub. No.: US 2005/0215699 A1
(43) Pub. Date: Sep. 29, 2005

(54) Adhesive system for wood bonding applications

(76) Inventors: Michael B. Doolin, Portland, OR (US); Gregory F. Nieckarz, Eugene, OR (US); Johan J. Rering, Eugene, OR (US)

Correspondence Address: CANTOR COLBURN, LLP, 55 GRIFFIN ROAD SOUTH, BLOOMFIELD, CT, 06002, US

(21) Appl. No.: 11/014,481

(22) Filed: Dec. 16, 2004

Related U.S. Application Data
(63) Continuation of application No. 10/391,163, filed on Mar. 18, 2003.

(51) Int. Cl. B32B 35/00; C08K 3/00

(52) U.S. Cl. 524/510; 524/512; 524/502

(57) ABSTRACT

The invention is directed to an adhesive system for wood containing a synergistic mixture of melamine-formaldehyde resin, phenol-formaldehyde resin, and cross-linked polyvinyl acetate emulsion resin wherein the mixture is cured by an acid.

### CROSS-REFERENCE TO RELATED APPLICATIONS

This application is a continuation application of U.S. patent application Ser. No. 10/391,163 filed on Mar. 18, 2003.

### FIELD OF THE INVENTION

The invention is directed to an adhesive system containing a synergistic mixture of mclamine-formaldehyde resin, phenol-formaldehyde resin, and cross-linkable polyvinyl acetate emulsion resin which is cured by an acid or heat.

### BACKGROUND OF THE INVENTION

Various processes of gluing or adhering together pieces of wood together are well known. One type of glued connection which is widely used in the timber processing industry is the finger-joint. The finger-joint is utilized in studs for vertical use and in laminated beams. This joint is made by a process whereby wedge-shaped fingers are machined into the end or side-grain of the pieces of timber to be joined and adhesives are applied to the exposed faces of the fingers. The fingers on any two pieces of wood are mated so that the protruding fingers on one piece of timber will slide into the grooves cut on the other piece, and end pressure is applied so that the wedge-shaped fingers “lock” together. The end pressure will also supply sufficient lateral pressure to the adhesive between the sloping faces of the finger so that the adhesive will satisfactorily bond the two pieces of timber together with sufficient strength and reliability. In structural laminated beam applications, several of the resulting pieces will be face glued together and used in load bearing situations. Finger-jointing is also widely used in non-structural applications to produce longer, finger-jointed lengths of good quality timber from wood having an unacceptably high number of defects.

Aqueous emulsions of polyvinyl acetate have been widely used as adhesives. The adhesive bonds derived from conventional cross-linkable polyvinyl acetate emulsions are poor with respect to their water resistance. Water soluble resins such as resorcinol-formaldehyde, urea-formaldehyde, melamine-formaldehyde, or phenol-formaldehyde resins have been added to aqueous emulsions of polyvinyl acetate to improve water resistance and other properties of these adhesives. This is because many vinyl acetate adhesives alone do not consistently meet ASTM standards for exterior non-structural lumber, especially ASTM D-575 1 and ASTM D-5572 for edge glued and finger jointed lumber in general.

Mudge et al. (U.S. Pat. No. 5,434,216) found that adhesives prepared from vinyl acetate N-methylol acrylamide polymer emulsion, which are stabilized with 1.5 to 2.5% by weight of 88% hydrolyzed polyvinyl alcohol and 1 to 4% by weight of 95-99.5% hydrolyzed polyvinyl alcohol, passed not only the finger jointed lumber requirements but also the ASTM D3110 requirements for edge glued lumber.

Walisser et al. (U.S. Pat. No. 5,952,440), incorporated herein by reference, teach a curable, alkaline, melamine modified, phenol-formaldehyde resin prepared from an initial phenol-formaldehyde resole resin containing from 0.5 to 2.5% of free formaldehyde by scavenging formaldehyde with 1 to 12 part of melamine for each 100 parts of the initial resin.

The use of melamine solids in liquid phenolic resoles for glass fiber bonding has had significant commercial importance because:
(i) Melamine reduces formaldehyde emission from the resole during C-stage (binder-curing) operations;
(ii) Nitrogen in the resulting melamine formaldehyde reaction product is bound in the highly thermally stable melamine molecule so that odoriferous decomposition products such as trimethylamine do not form during the normally encountered high temperature curing operations used to cure the binder. Odoriferous trimethylamine formation is a significant problem for certain applications when a urea containing phenolic resole is used as the binder since urea is a thermally unstable material;
(iii) Melamine itself has enough water solubility to enable its direct addition to dilute glass fiber binders;
(iv) Melamine itself fonrts stable dispersion with aqueous phenolic resoles; and
(v) Melamine is a non-toxic, non-hazardous, relatively inexpensive, high tonnage chemical.

Conventional wood adhesives contain resins that are cured with acids, bases, or heat. If the pH of a cured adhesive falls below 2.5, industrial standards deem the product useless for structural use because the wood becomes more susceptible to
degradation. The pH of an adhesive before curing is referred to as the wet pH. The cured glue line pH on glass as described in ASTM D 1583 is referred to as the cured pH. Conventional two-part catalyzed cross linkable polyvinyl acetate resins have a wet pH of about 1 to 3, and often have a cured pH below 2.5.

Accordingly, a present need exists for an adhesive system for wood that exhibits superior adhesive properties, cures quickly at ambient temperatures, radio frequencies (R/F), and hot press cures, is light in color, and has a cured glue line pH above 2.5 for structural applications.

### SUMMARY OF THE INVENTION

Embodiments of the present invention are directed to adhesive systems containing a mixture of a melamine-formaldehyde resin, a phenol-formaldehyde resin, and a cross-linkable polyvinyl acetate emulsion resin, wherein the mixture is cured with an acid or heat.

### BRIEF DESCRIPTION OF THE DRAWINGS

FIG. 1 compares the average strength of cold set Douglas Fir billets made with an adhesive of the present invention to the average strength of Douglas Fir billets made with the individual components of the adhesive wherein the pH of the adhesive ranged from about 2.5 to about 4. The break load of the billets was measured after a one-cycle, four-hour boil test.

FIG. 2 compares the average strength of cold set Douglas Fir billets made with an adhesive of the present invention to the average strength of Douglas Fir billets made with the individual components of the adhesive wherein the pH of the adhesive ranged from about 2.5 to about 4. The break load of the billets was measured after AVP testing.

FIG. 3 compares the wood failure % of cold set Douglas Fir billets made with an adhesive of the present invention to the wood failure of Douglas Fir billets made with the individual components of the adhesive wherein the pH of the adhesive ranged from about 2.5 to about 4. The wood failure % of the billets was measured after a one-cycle, four-hour boil.

FIG. 4 compares the wood failure % of cold set Douglas Fir billets made with an adhesive of the present invention to the average strength of Douglas Fir billets made with the individual components of the adhesive wherein the pH of the adhesive ranged from about 2.5 to about 4. The wood failure % of the billets was measured after AVP testing.

FIG. 5 illustrates the durability of Douglas Fir billets made with adhesives of the present invention, Wonderbond MR-70, and a Phenol-Resorcinol-Formaldehyde (PRF) resin after 6-cycle, 24-hour boil and AVP tests. The adhesives were cured by radio frequency (RJF) at various speeds of set.

FIG. 6 illustrates the wood failure % of Douglas Fir billets made with adhesives of the present invention, Wonderbond MR-70, and a Phenol-Resorcinol-Formaldehyde (PRF) resin after 6-cycle, 24-hour boil and AVP tests. The adhesives were cured by radio frequency (R/F) at various speeds of set.

FIG. 7 compares the average break load of cold set Douglas Fir billets made with various ratios of Wouderbond EPR-47 and Wonderbond MR-70 after a 2 cycle, eight hour boil test.

FIG. 8 compares the average break load of cold set Douglas Fir billets made with various ratios of Wonderbond EPR-47 and Wonderbond MR-70 after an AVP test.

FIG. 9 compares the wood failure % of cold set Douglas Fir billets made with various ratios of Wonderbond EPR-47 to Wonderbond MR-70 after a two cycle, eight hour boil test.

FIG. 10 compares the wood failure % of cold set Douglas Fir billets made with various ratios of Wonderbond EPR-47 to Wonderbond MR-70 after an AVP test.

FIG. 11 shows the average wood failure % of cold-set Douglas Fir billets made with various ratios of Buffered Wonderbond EPR-47 and Wonderbond MR-70 after being subjected to 2 cycle, eight hour boil, a 10 cycle, 40 hour boil, and AVP tests.

FIG. 12 illustrates the average break load of cold-set Douglas Fir billets made with various ratios of buffered Wonderbond EPR-47 and Wonderbond MR-70 after being subjected to 2 cycle, eight hour boil, 10 cycle, 40 hour boil, and AVP tests.

FIG. 13 illustrates the results of an ASTM D-2559 Delamination test on cold-set Douglas Fir laminated beams.

FIG. 14 illustrates the results of an ASTM D-2259 Delanimation test on cold-set Southern Yellow Pine laminated beams.

### DETAILED DESCRIPTION OF THE INVENTION

Embodiments of the present invention provide an adhesive containing a novel combination of components that show superior adhesion properties in a number of industrially important applications that include, but are not limited to wood, or wood-containing substrates in face, edge, finger-joint, or route (web and flange) orientations. The adhesive system contains a mixture containing a melamine-formaldehyde resin, a phenol-formaldehyde resin, and a crosslinkable polyvinyl acetate emulsion resin, wherein the mixture is cured with an acid and/or heat. By varying the amounts of the components, as well as the acid, the adhesive system may take on different bonding characteristics to meet different requirements for bonding.

A variety of melamine-formaldehyde resins and processes for their preparation are known. The melamine-formaldehyde resin includes methylated and non-methylated melamine-formaldehyde resins. Examples include, but are not limited to Cascomel MF-2L, Wonderbond MR-70, Cascomel MF-1L, Cascomel MO-608B (available from Borden Chemical, Inc. of Columbus, Ohio), and combinations thereof. A preferred melamine-formaldehyde resin is Wonderbond MR-70. The melamine-formaldehyde resin is present in an amount ranging from about 5 to about 50 wt. %, based on the total weight of the mixture.

A variety of phenol-formaldehyde resins and processes for their preparation are known. The phenol-formaldehyde resin includes, but is not limited to high molecular weight phenolic resins. Preferred phenol-formaldehyde resins are Cascophen 433-156 and Cascophen 433-156A, available from Borden Chemical, Inc. of Columbus, Ohio. The phenol-formaldehyde resin is present in an amount ranging from about 10 to about 50 wt. %, based on the total weight of the mixture. The cross-linkable polyvinyl acetate emulsion resin includes, but is not limited to Polyvac MB-CB, Polyvac MB-42 1, and combinations thereof A preferred cross-linkable polyvinyl acetate emulsion resin is Polyvac MB-CB, available from Franklin International of Columbus, Ohio. The cross-linkable polyvinyl acetate emulsion resin is present in an amount ranging from about 23 to about 72 wt. %, based on the total weight of the mixture.

The phenol-formaldehyde resole may be combined with the cross-linkable polyvinyl acetate emulsion resin. A product which contains the combination of phenol-formaldehyde resole and cross-linkable polyvinyl acetate emulsion is Wonderbond EPR-47, available from Borden Chemical, Inc. of Columbus, Ohio.

A preferred acid is an acid that falls into the definition of either a Bronsted acid (i.e., any molecular or ionic species that can act as a proton donor) or a Lewis acid (i.e., any molecular or ionic species that can act as an electron pair acceptor). Bronsted acids include, but are not limited to formic acid, methane sulfonic acid, and toluene sulfonic acid. Preferred Bronsted acids are Wonderbond Hardener M-400L and Wonderbond Hardener M-600L, available from Borden Chemical, Inc. of Columbus, Ohio. A preferred Lewis acid is aluminum chloride, preferably M-3 18 LY, available from Borden Chemical, Inc. of Columbus, Ohio. The acid is present in an amount ranging from about 1 to about 20 wt. %, based on the total weight of the mixture. However, this amount will vary with the particular dilution employed. Typical dilutions for the acids range from about 28 to about 95 wt. %. An effective amount of acid is the amount of acid sufficient to impart a pH of the mixture to about 1 to about 5, preferably about 3.5 to about 4.5.

The components of the adhesive mixture of the present invention may be blended together without regard to any particular order. The adhesive mixture of the present invention may be prepared by first mixing a melamine-formaldehyde resin with a combination of phenol-formaldehyde resin and cross-linkable polyvinyl acetate emulsion. After the mixture of the melamine-formaldehyde resin, the phenol-formaldehyde resin and the cross-linkable polyvinyl acetate emulsion is thoroughly blended, an acid is added.

The adhesive of the present invention may additionally be prepared by premixing the phenol-formaldehyde resin, the cross-linkable polyvinyl acetate emulsion, and the acid. The melamine-formaldehyde resin is then blended with the premix.

The adhesive of the present invention may further be prepared by premixing the acid with the polyvinyl acetate emulsion or the melamine-formaldehyde, and then adding the remaining components.

A preferred embodiment of the present invention includes a mixture of 70 pbw (parts by weight) of Wonderbond EPR-47, 30 pbw of Wonderbond MR-70, and 10
pbw of 95% formic acid solution in water or 10 pbw of 70% methane sulfonic acid solution in water.

The adhesive of the present invention may be applied to a variety of soft and hard woods, including, but not limited to, Douglas Fir, White Fir, Hemlock, Larch, Southern Yellow Pine, Ponderosa Pine, and combinations thereof. The preferred woods are Douglas Fir, Ponderosa Pine, and Southern Yellow Pine.

The adhesive of the present invention may be employed in various wood applications wherein the joining of two or more pieces of solid wood or composite wood is needed. One embodiment is applying the adhesive to vertical fingerjoints or face-laminating surfaces. The adhesive is applied between two pieces of wood, and pressure of about 400-800 psi for vertical fingerjoints and 150 psi for laminating surfaces is applied to the joined wood for about 30 seconds for finger joints and 12 hours for laminated surfaces. Thereafter, the joined wood is allowed to cure at ambient temperatures greater than 70˜F for 24 hours or more.

Adhesive systems of the present invention were evaluated by making two-ply billets of Douglas Fir. Douglas Fir was cut into plies measuring 2½ inches wide by 12 inches long by 3/4 inch thick. The individual plies were weighed, and two plies having equal weight and grain orientation were joined together with the adhesive to be evaluated. Pressure of about 150 psi was applied to the billets at ambient temperatures greater than 700 F for about 12 hours. This is referred to as “cold set.” Curing of other billets was by R/F for specified time periods. The billets were then cut into five equal test samples. The test samples were subjected to two-cycle, eight-hour boil; ten-cycle, 40-hour boil; and cold water accelerated vacuum pressure (AVP) tests. For a two-cycle, eight-hour boil test, a test sample is boiled in water for two consecutive cycles lasting for a period of four hours for each cycle. For a ten-cycle, 40-hour boil, a test sample is boiled in water for 10 consecutive cycles lasting four hours for each cycle. The AVP test and the 2 cycle, 8 hours boil test were carried out according to ASTM 575 1-99.

After the boil and AVP tests, the glue bond of the billets were tested for shear strength and wood failure according to ASTM D-5572 and D-575 1. After the test samples were sheared, the areas of breakage were studied. If the entire shear area or tension area was on the wood, this was 100% wood failure. If the entire area was in the adhesive bond, this was a 0% wood failure. The higher the percent of wood failure, the better the adhesive bond. Break load testing was conducted according to ATSM D-575 1, using a testing machine available from Tinius Olsen Universal Testing Machine of Philadelphia, Pa.

Additionally, six-ply beams of either Douglas Fir or Southern Yellow Pine were made with adhesives of the present invention. Individual plies measured ¼ inches thick by 5½ inches wide by 18 inches long. The individual plies were weighed, and six plies having equal weight and grain orientation were joined together with the adhesive to be evaluated. Pressure of about 150 psi was applied to the beams at ambient temperatures greater than 700 F for about 12 hours. The beams were cut into four equal test samples.

Adhesive systems of the present invention were further evaluated by making cold set finger-jointed studs and testing for modulus of rupture (MOR) and shear strength according to WWPA 101.97.

### EXAMPLE 1

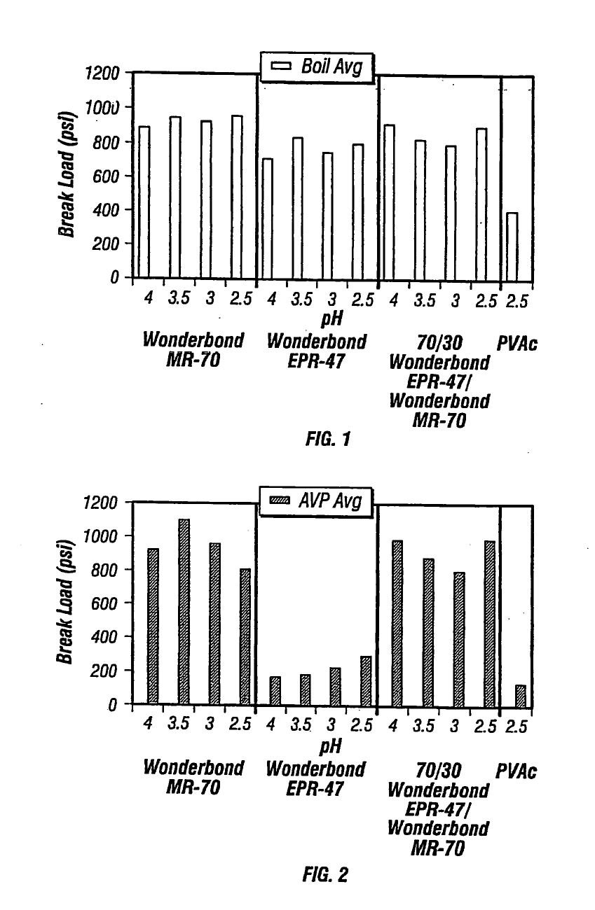

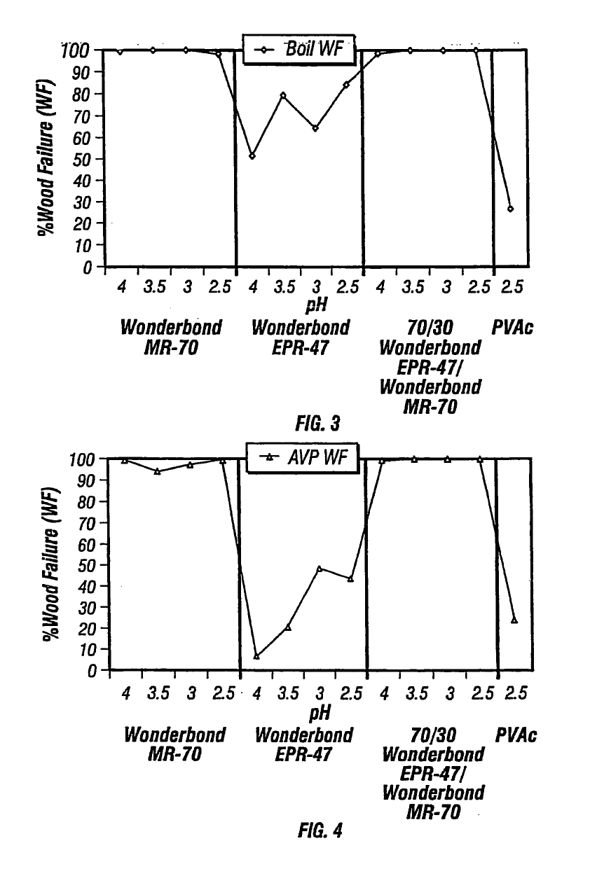

The synergism of the adhesive mixture of the present invention was demonstrated by comparing the physical properties of Douglas Fir billets made with the individual components of the adhesive mixture of the present invention with Douglas Fir billets made with the novel mixture of the present invention at various pHs. The Douglas Fir billet test samples were subjected to boil and cold water accelerated vacuum pressure (AVP) and tested for break load (psi) and wood failure (WF). The melamine formaldehyde resin was Wonderbond MR-70. The phenol formaldehyde resin with cross-linkable polyvinyl acetate emulsion was Wonderbond EPR-47. The cross-linkable polyvinyl acetate emulsion was Polyvac MB-CB (PVAc). The adhesive mixture representative of the present invention was 70 pbw Wonderbond EPR-47 and 30 pbw Wonderbond MR-70. The pH of the adhesive systems was adjusted to the desired pH with 95% formic acid (Wonderbond Hardener M-600L). Twenty samples were made containing each of the above adhesives. The average break load and wood failure value was determined by adding all the values obtained in each group of samples and dividing by the number of sample pieces in the group. The results are shown in FIGS. 1-4.

As shown in FIGS. 1-4, the adhesive mixture of the present invention exhibits better boil and AVP strength and wood failures that its individual components. The adhesive mixture of the present invention also had better AVP strength and wood failure properties than the melamine formaldehyde resin (Wonderbond MR-70) at a cured pH of 2.5.

### EXAMPLE 2

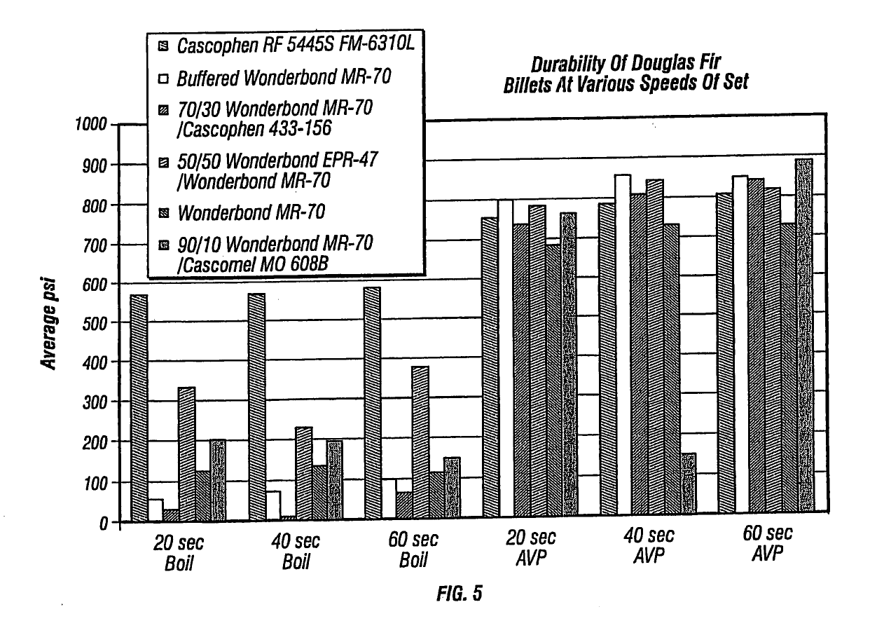

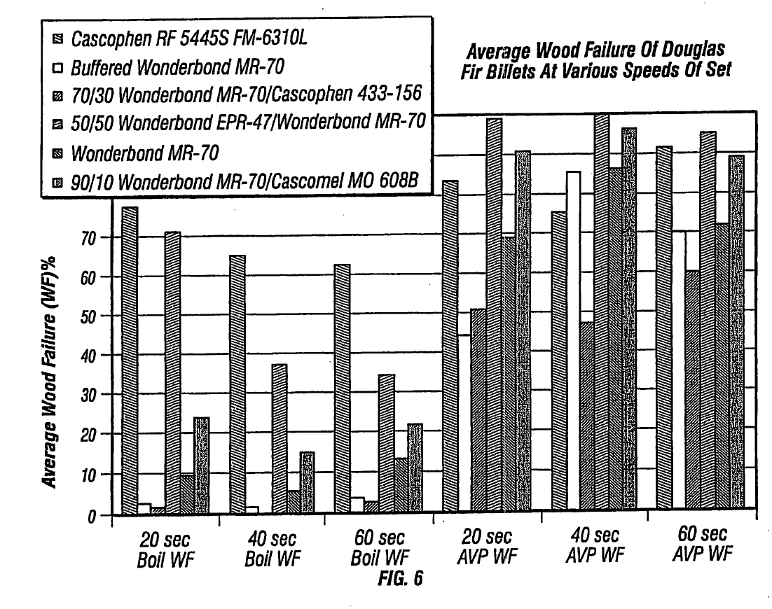

Douglas Fir billets were made with various adhesives that were radio frequency (R/F) cured. The R/F curing was accomplished with a 5 kilowatt radio frequency generator, available from L&L Machinery of N. Wilkesboro, N.C., set at 0.44 to 6.0 amps. The samples were exposed to R/F for 20, 40, and 60 seconds. Ten test sample pieces, containing each of the above adhesives underwent a 6-cycle, 24-hour boil test and AVP test. The pH was adjusted to 3.5 with Wonderbond Hardener M-600L for the adhesive systems apart from the Cascophen RF 5445S and Cascoset FM-6310L adhesive system. The pH of the Cascophen RE 5445S and Cascoset FM-63 1 OL adhesive system was 8. The following adhesives were evaluated: 2.3:1 Cascophen RE 5445S: Cascoset FM-63 1OL; Wonderbond MR-70 buffered with 3 wt. % sodium formate (based on the total weight of the composition); 70:30 parts Wonderbond MR-70: Cascophen 433-156; 50:50 parts Wonderbond EPR-47: Wonderbond MR-70; Wonderbond MR70; and 90 parts Wonderbond MR-70 and 10 parts Cascomel MO-608B. The average durability and wood failure values are shown in FIGS. 5 and 6.

The Cascophen RE 5445 S and Cascoset FM-63 1 OL adhesive system is a PhenolResorcinol-Formaldehyde (PITh), highly cross-linked thermoset resin. The Cascocet FM-63 1 OL is a paraformaldehyde catalyst. As shown in FIG. 5, the adhesive mixture of the present invention had comparable AVP strengths and better AVP wood failures when compared to the Cascophen RE 5445 S and Cascoset FM-63 IOL adhesive system.

FIGS. 5 and 6 further show that the adhesive mixture of the present invention shows better water boil and AVP strength than melamine resins alone.

### EXAMPLE 3

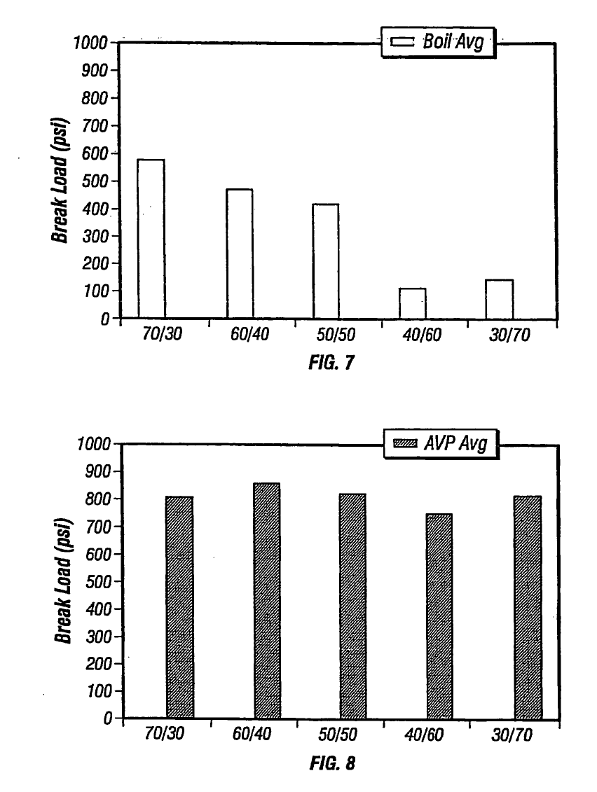

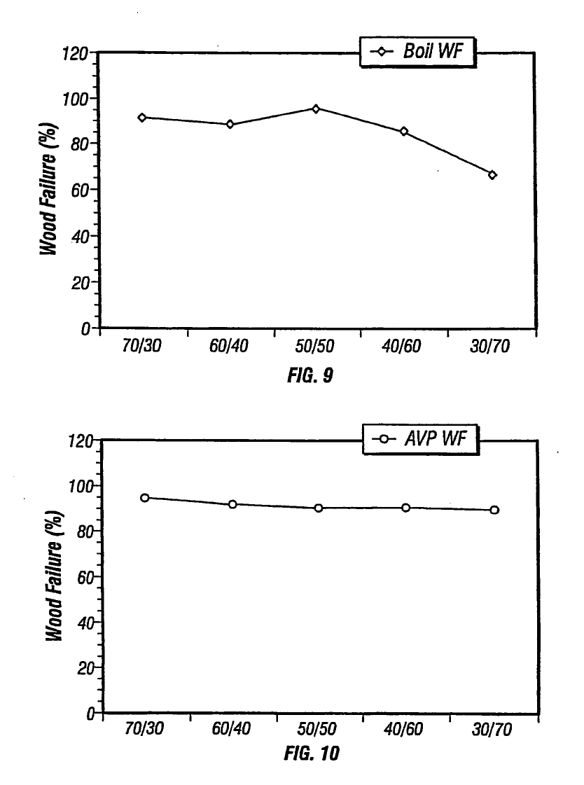

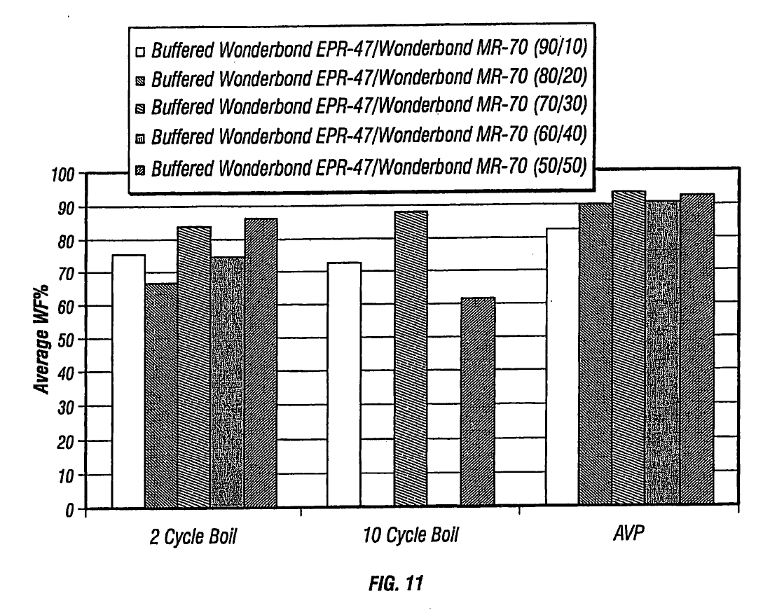

Douglas Fir beams were made using various ratios of Wonderbond EPR-47 and Wonderbond MR-70 at a pH of 2.5. Ten billet sample pieces containing each of the various ratios were tested. The mixture of Wonderbond EPR-47 and Wonderbond MR-70 was acidified with 10 pbw of Hardener M-600L. The strengths and wood failure percentages for the sample pieces after a two-cycle, eight-hour boil and AVP are shown in FIGS. 7, 8, 9, and 10.

As shown in FIGS. 7, 8, 9, and 10, the adhesive mixtures having greater than 50% Wonderbond EPR-47 have desired bond strengths and wood failure properties.

### EXAMPLE 4

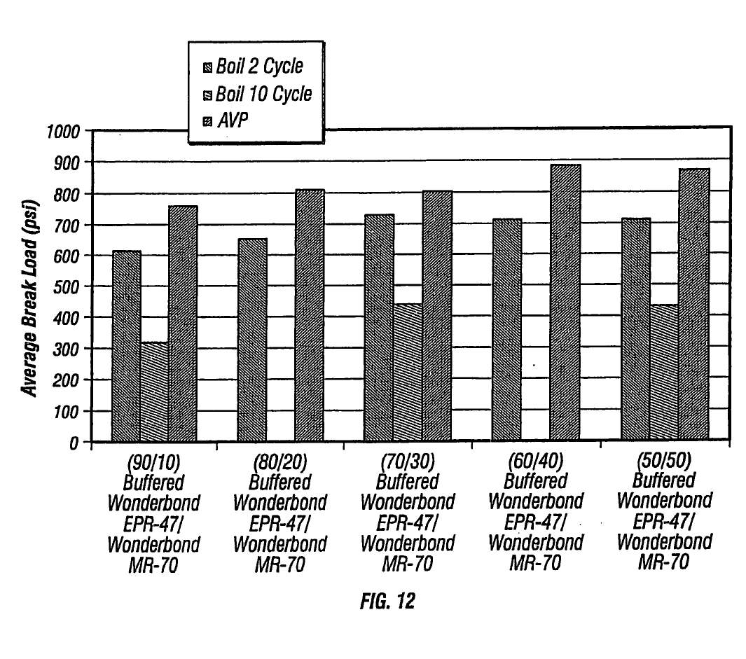

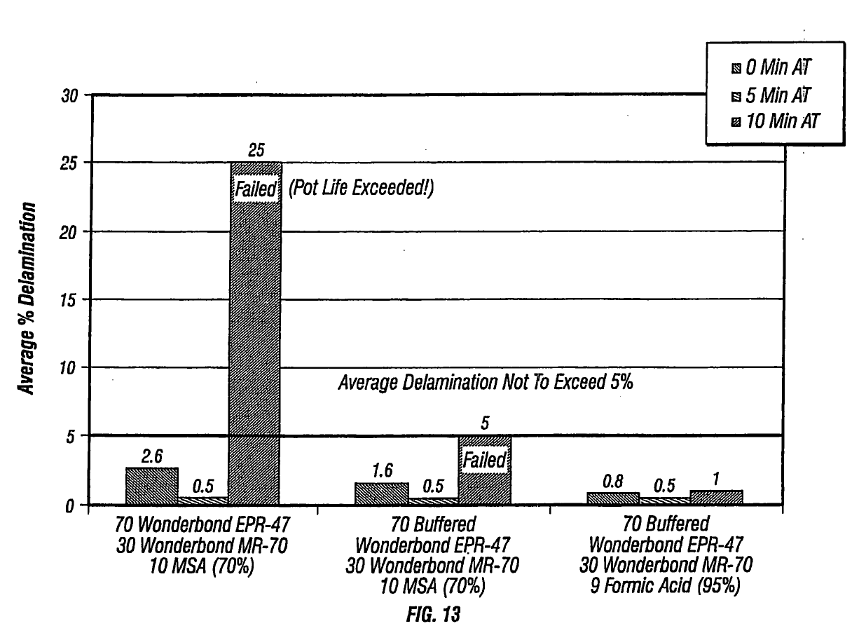

Two-ply billets of Douglas Fir were made according to the procedure described in ASTM D 5751-99; however, various ratios of Wonderbond EPR-47 buffered with 3 wt. % sodium formate and Wonderbond MR-70 were employed as the adhesive. Six billets of each group were subjected to a 2 cycle boil, a 10 cycle boil, and AVP, and thereafter wood failure percentages and break loads were determined. The results are shown in FIGS. 11 and 12.

As shown by FIG. 11, the 70:30 ratio of Wonderbond EPR-47 buffered with 3 wt. % sodium formate to Wonderbond MR-70 had the highest 10 cycle boil and AVP wood failures percentages.

As shown in FIG. 12, the 70:30 ratio of Wonderbond EPR-47 buffered with 3 wt. % sodium formate to Wonderbond MR-70 performed better in 2 and 10 cycle water boil strength tests.

### EXAMPLE 5

Six ply cold set Douglas Fir test samples were cut from beams made with various ratios of the adhesive system of the present invention. The beams were made according to the procedure outlined in ASTM D-2559. The adhesive systems evaluated were 70 pbw Wonderbond EPR-47, 30 pbw Wonderbond MR-70, and 10 pbw 70% methane sulfonic acid; 70 pbw Wonderbond EPR-47 buffered with 3 wt. % sodium formate, 30 pbw Wonderbond MR-70, and 10 pbw 70% methane sulfonic acid; and 70 pbw Wonderbond EPR-47 buffered with 3 wt. % sodium formate, 30 pbw Wonderbond MR-70, and 9 pbw 95% Formic Acid. ASTM D-2559 Delamination Test were conducted on the test samples. The results are shown in FIG. 13.

### EXAMPLE 6

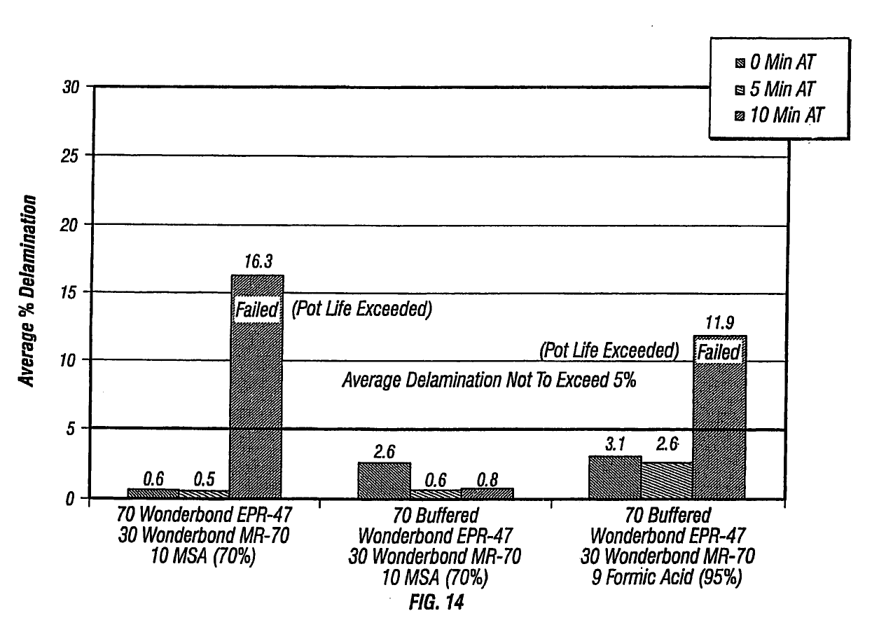

Southern Yellow Pine billet samples were made according to the procedure described in Example 5. The results of the ASTM-D-2559 Delamination Test is shown in FIG. 14.

### EXAMPLE 7

2 inch by 4 inch by 8 foot cold set finger jointed studs were made using an adhesive of the present invention. The specifications for cold set finger jointed studs are found in Part A of Procedures For Mill Certification and Quality Control, Glued Products, Western Wood Products Association (August 1998).

The adhesive was made by premixing 75 pbw Wonderbond EPR-47 with 2 pbw Hardener M-400L and placing the mixture in a hold tank. This premix was then automatically blended with 25 pbw Wonderbond MR-70, using a Rook automatic mixer, available from Rook Metering/Michael Engineering of Mount Pleasant, Mich. and a 15″ static mix tube. The adhesive was applied to the stock and placed on a continuous press, where pressure from about 400 to about 800 psi was applied for 3 seconds. The amount of pressure varied according to the species of wood, e.g., 800 psi for Douglas Fir and 400 psi for White Fir. The glued wood was moved laterally for 210 seconds, during which period the glued stock post cured to a rough handling bond. The stock included White Fir and Spruce, Hemlock, and a combination of Douglas Fir and Larch. The temperature of the stock was 380 F and the moisture content was 19% or less. Sample sizes of 1.5 by 1.5 by 36 inches were tested for MOR and wood failure. The results are shown in Tables 1, 2, and 3.

TABLE 1
Test Results for Douglas-Fir/Larch

| Sample Number | MOR (Psi) | Wood Failure (%) |
|---|---|---|
| 1 | 5777 | 100 |
| 2 | 5393 | 100 |
| 3 | 5009 | 100 |
| 4 | 5393 | 100 |
| 5 | 4625 | 100 |

TABLE 2
Test Results for White Fir and Spruce

| Sample Number | MOR (Psi) | Wood Failure % |
|---|---|---|
| 1 | 8079 | 100 |
| 2 | 5777 | 100 |

TABLE 3
Test Results for Hemlock

| Sample Number | MOR (Psi) | Wood Failure % |
|---|---|---|
| 1 | 5009 | 90 |
| 2 | 3474 | 100 |

### EXAMPLE 8

2″×6″×8′ cold set finger jointed studs were made by the same procedure stated in Example 8 with hemlock and a combination of Douglas Fir and Larch. The samples were tested for MOR and wood failure. The results are shown in Table 4, 5, and 6.

TABLE 4
Test Results for Hemlock

| Sample Number | MOR (Psi) | Wood Failure % |
|---|---|---|
| 1 | 2927 | 90 |
| 2 | 3291 | 100 |
| 3 | 3655 | 100 |
| 4 | 2564 | 100 |
| 5 | 4625 | 100 |
| 6 | 5777 | 100 |

TABLE 5
Test Results for Douglas Fir/Larch

| Sample Number | MOR (Psi) | Wood Failure % |
|---|---|---|
| 1 | 4382 | 100 |
| 2 | 3291 | 100 |
| 3 | 5109 | 100 |
| 4 | 5473 | 100 |
| 5 | 2564 | 100 |
| 6 | 3291 | 100 |
| 7 | 3566 | 100 |
| 8 | 6200 | 100 |
| 9 | 5473 | 100 |
| 10 | 6927 | 100 |

### EXAMPLE 9

10 ml of the adhesives indicated in Table 6 was place in a 15 mm ID test tube. The pH of the adhesives was adjusted to the pH indicated in Table 6 with 95% formic acid. The test tube was then immersed in a 70° C. water bath. Two metal sensors were immersed in the test tube and spun. When a sudden, pronounced increase in the viscosity of the adhesive was encountered, a Sunshine 22A Gel Timer, available from Sunshine Instruments of Philadelphia, Pa. sounded an alarm. The time between the initial immersion in the water and the sounding of the alarm is defined as the “gel time.” The shorter the gel time, the faster the resin cure speed. The results are shown in Table 6.

TABLE 6

| ADHESIVE | pH | GEL TIME |
|---|---|---|
| Wonderbond MR-70 | 4.42 | 197 |
| Wonderbond EPR-47 | 2.66 | 155 |
| 50/50 Wonderbond MR-70/ | 3.85 | 127 |
| Wonderbond EPR-47 | | |
| 50/50 Wonderbond MR-70/ | 4.44 | 308 |
| Wonderbond EPR-47 | | |
| 70/30 Wonderbond MR-70/ | 4.40 | 191 |
| Wonderbond EPR-47 | | |

As shown in Table 6, the adhesive mixture containing 50 parts Wonderbond MR-70 and 50 parts Wonderbond EPR-47 had the fastest cure speed at a pH of 3.85.

1. An adhesive system comprising a mixture of:
a) a melamine-formaldehyde resin;
b) a phenol-formaldehyde resin; and
c) a cross-linkable polyvinyl acetate emulsion resin, wherein the mixture is cured with an acid.

2. The adhesive system of claim 1, wherein the melamine-formaldehyde resin is present in an amount ranging from about 5 to about 50 wt. %, based on the total weight of the mixture.

3. The adhesive system of claim 1, wherein the phenol-formaldehyde resin is present in an amount ranging from about 10 to about 50 wt. %, based on the total weight of the mixture.

4. The adhesive system of claim 1, wherein the cross-linkable polyvinyl acetate emulsion resin is present in an amount ranging from about 23 to about 72 wt. %, based on the total weight of the mixture.

5. The adhesive system of claim 1, wherein the acid is a 95% solution of formic acid in water.

6. The adhesive system of claim 5, wherein the formic acid is present in an amount ranging from about 1 to about 20 wt. %, based on the total weight of the mixture.

7. The adhesive system of claim 1, wherein the acid is a 70% methane sulfonic acid solution in water.

8. The adhesive system of claim 7, wherein the methane sulfonic acid is present in an amount ranging from about 1 to about 20 wt. %, based on the total weight of the mixture.

9. The adhesive system of claim 1, wherein the acid is a 70% toluene sulfonic acid solution in water.

10. The adhesive system of claim 9, wherein the toluene sulfonic acid is present in an amount ranging from about 1 to about 20 wt. %, based on the total weight of the mixture.

11. The adhesive system of claim 1, wherein the acid is aluminum chloride.

12. The adhesive system of claim 11, wherein the aluminum chloride is present in an amount ranging from about 1 to about 20 wt. %, based on the total weight of the mixture.

13. The adhesive system of claim 1, wherein the mixture has a pH ranging from about 1 to about 5.

14. The adhesive system of claim 1, wherein the mixture has a pH ranging from 3.5 to 4.5.

15. The adhesive system of claim 1, wherein the mixture is cured with heat.
